(19) United States
(12) Patent Application Publication
(10) Pub. No.: US 2015/0360231 A1
(43) Pub. Date: Dec. 17, 2015

(54) METHOD AND SYSTEM FOR PROCESSING ORE-CONTAINING MATERIAL

(71) Applicant: THYSSENKRUPP INDUSTRIAL SOLUTIONS AG, Essen (DE)

(72) Inventors: Matthias KESSLER, Beckum (DE); Egbert BURCHARDT, Everswinkel (DE); Richard ERPELDING, Soest (DE)

(21) Appl. No.: 14/651,362

(22) PCT Filed: Nov. 13, 2013
(86) PCT No.: PCT/EP2013/073739

§ 371 Date: Aug. 3, 2015

(30) Foreign Application Priority Data
Dec. 11, 2012 (DE) 10 2012 112 093.5

(51) Int. Cl. B02C 23/14; B03C 1/30; B03B 7/00; B07B 15/00; B02C 23/12; B07B 9/00

(52) U.S. Cl. CPC B02C 23/14; B02C 23/12; B07B 9/00; B03B 7/00; B07B 15/00; B03C 1/30

(57) ABSTRACT

A method and system for processing ore-containing material is provided. The material is comminuted in at least one first mill. The comminuted material is classified in a first classification into coarse and fine material. At least part of the coarse material of the first classification is returned back to the first mill. The fine material of the first classification is classified in a second classification again into coarse and fine material. The coarse material of the first classification is subjected to a first sorting into a first valuable and a first less valuable fraction. The first valuable fraction is returned to the first mill and the less valuable fraction is discarded.

### FIELD

The disclosure relates to a method and system for processing ore-containing material, in particular magnetite or hematite ore.

### BACKGROUND

When ores are processed, the material is usually comminuted and classified in a plurality of cycles, wherein the valuable material is retrieved by sorting. In the case of magnetite ores, the valuable material is separated by wet magnetic separation. A method for the fine comminution of ores is known from DD 112 609, for example. Further methods for processing ore are disclosed in US 2006/0 243 832 A1, CN 102 239 014 A, and CN 102 228 889 A.

### SUMMARY

The invention is now based on the object of reducing the effort for processing material, in particular iron ore or iron ore-containing material.

The method according to the invention for processing ore-containing material, in particular magnetite or hematite ore, is provided. The material is comminuted in at least one first mill. The comminuted material is classified in a first classification into coarse and fine material. At least part of the coarse material of the first classification is returned to the first mill. The fine material of the first classification is classified in a second classification again into coarse and fine material. The coarse material of the first classification is optionally subjected to a first sorting into a first valuable and a first less valuable fraction, wherein the first valuable fraction is returned to the first mill and the less valuable fraction is discarded. The coarse material of the second classification is subjected to a second sorting into a second valuable and a second less valuable fraction, wherein the second valuable fraction is returned to the first mill and the second less valuable fraction is discarded. The fine material of the second classification is subjected to a third classification and subsequently to at least one third and/or fourth sorting.

A system according to the invention for processing ore-containing material includes at least one first mill for comminuting the material. A first classification installation for classifying the material which is comminuted in the first mill has a first fine-material outlet and a first coarse-material outlet, wherein the first coarse-material outlet is connected to the mill in order for coarse material to be recirculated. A second classification installation which is connected to the first fine-material outlet of the first classification installation, having a second fine-material outlet and a second coarse-material outlet. An optionally present first sorting installation which is connected to the first coarse-material outlet of the first classification installation, having a first outlet for a first valuable fraction and a second outlet for a first less valuable fraction, wherein the first outlet is connected to the mill in order for the first valuable fraction to be recirculated. A second sorting installation which is connected to the second coarse-material outlet of the second classification installation, having a first outlet for a second valuable fraction and a second outlet for a second less valuable fraction, wherein the first outlet is connected to the mill in order for the second valuable fraction to be recirculated. A third classification installation which is connected to the second fine-material outlet of the second classification installation. At least one third and/or fourth sorting installation which is connected to the third classification installation.

A classification installation in the context of the invention is understood to mean installations with the aid of which an infed material flow is separated into at least two different grain-size classes. This may be performed with the aid of a sieve, for example. If a screening air flow is used for classifying, the classification installation is referred to in the following description as a screen which may be configured as desired as a static screen or a dynamic screen.

According to the invention, the object stated above is achieved in that at least part of the material which is returned to the mill is already sorted, such that the proportion of the recirculated material is reduced by the mine-waste proportion (discarded less valuable fraction).

On account of the provision of three classifications or screenings, the possibility exists for at least the coarse material of the second classification installation to be sorted into a valuable fraction and a less valuable fraction, wherein only the valuable fraction is recirculated to the mill. The transient material, that is to say that material which is fed to the first mill for re-comminuting, may be reduced by about 20% in this way. In turn, this means that the mill may be configured so as to be correspondingly smaller, or that the system may be operated at a correspondingly higher throughput. Wear of the mill is also correspondingly reduced.

Further design embodiments of the invention are the subject matter of the dependent claims.

Preferably, the first mill is configured for comminuting the material bed and may be formed by a bowl mill crusher or a material bed crushing mill.

According to a further design embodiment of the invention, coarse material created in the third screening is subjected to the third sorting into a third valuable and a third less valuable fraction, wherein at least part of the third valuable fraction is further comminuted in a second mill which is configured as a ball mill, for example, and preferably as an agitator ball mill. In particular for material which is in a grain-size range of <250 μm, such as is present in the second mill, the agitator ball mill, as opposed to a ball mill, enables energetically more efficient comminution with reference to the target grain size of approx. 45 μm.

The third valuable fraction which is comminuted in the second mill preferably is subsequently subjected to a fourth sorting into a fourth valuable and a fourth less valuable fraction. This sorting may be performed as fluidized bed sorting, for example, or by way of wet magnetic separation, in particular.

Fine material which is created in the third screening is divided in a further sorting, in particular together with the material which is comminuted in the second mill, into a fourth valuable and a fourth less valuable fraction. Sensor-supported sorting and/or dry density sorting in a dry jigger, for example, may be considered for the first and second sorting. Preferably, fluidized bed sorting may also be applied in the third sorting. Preferably, however, dry magnetic separation is to be considered for the first, second, and third sorting. Wet magnetic separation is only applied in the last sorting, when the material has a grain size of ≦45 μm, for example, as this is presently the only practicable solution for separating this grain size. However, the overall requirement for process water is significantly reduced by the preceding dry sorting operations.

If the raw material is a material with a comparatively high water content, according to a further design embodiment of the invention the first and/or second and/or third classification are/is performed as screening with a hot gas flow. Here, the fine material which is created in the third classification (screening), together with the hot gas flow, may be fed to a downstream separator, in particular a filter or a cyclone, wherein the hot gas flow which is separated there is returned to the first, second and/or third classification installation and the fine material is fed to further, in particular the fourth, sorting.

### DETAILED DESCRIPTION OF THE DRAWINGS

Further design embodiments and advantages of the invention will be explained in more detail in the following by means of the description and the drawing, in which:

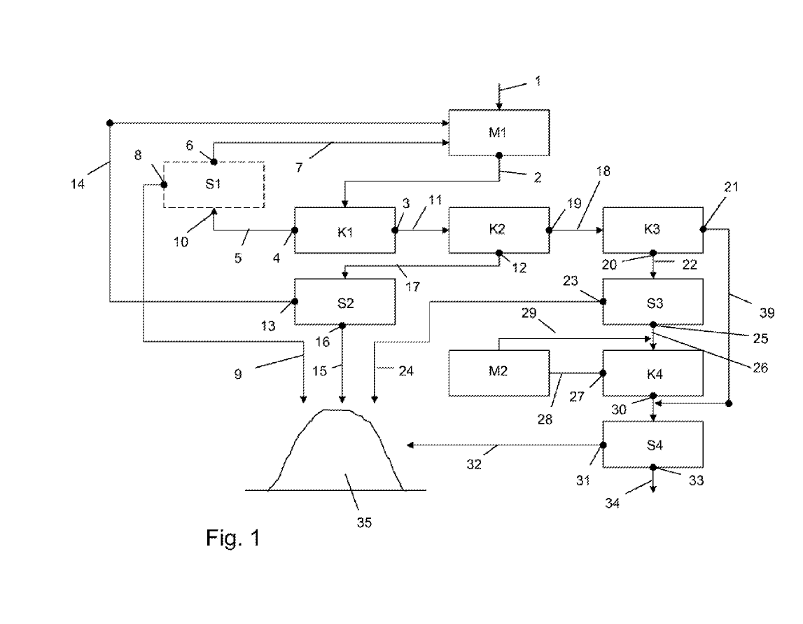

FIG. 1 shows a block diagram of a system according to the invention for processing material; and

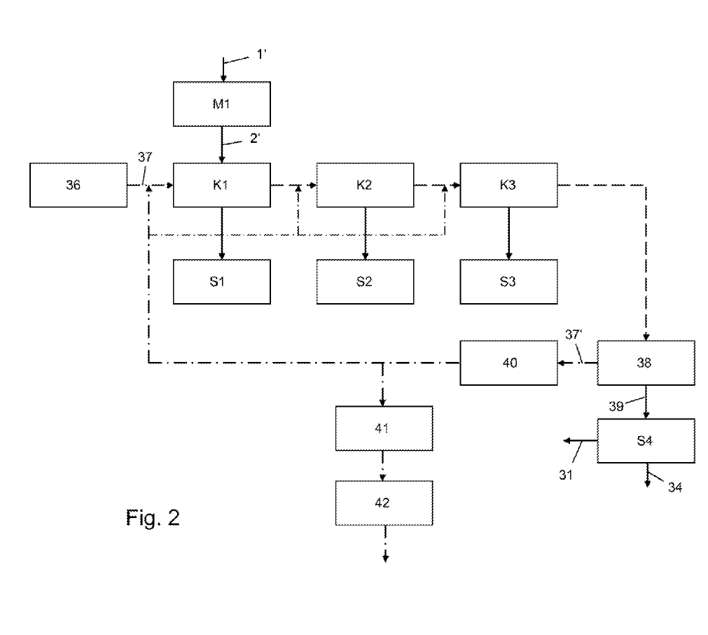

FIG. 2 shows a block diagram of a system according to the invention, according to FIG. 1, having a hot gas generator for processing raw material with a comparatively high water content.

### DETAILED DESCRIPTION

FIG. 1 shows a system for processing material 1, in particular iron ore or material containing iron ore. Said system has a first mill M1 for comminuting the material 1, which is configured for example as a bowl mill crusher or a material bed crushing mill. Said mill M1 is connected to a first classification installation K1 for classifying the material 2 which is comminuted in the first mill M1. The first classification installation K1 may be configured as a sieve or as a static screen, for example, and has a first fine-material outlet 3 and a first coarse-material outlet 4. The first coarse-material outlet 4 is connected to the first mill M1, in order to recirculate the coarse material 5 which accumulated in the first classification installation K1, wherein an optional first sorting installation S1 may be disposed therebetween. The optional first sorting installation S1 is provided with a first outlet 6 for a first valuable fraction 7 and with a second outlet 8 for a first less valuable fraction 9, wherein the first coarse-material outlet 4 of the first classification installation K1 is connected to an inlet 10 of the first sorting installation S1, and the first outlet 6 of the sorting installation S1 is connected to the first mill M1, in order for the first valuable fraction 7 to be recirculated. The first sorting installation S1 may be sensor-supported sorting, a dry jigger, or dry magnetic separation, for example.

If the material 1 to be processed is ore containing magnetite, the first valuable fraction 7 is composed of magnetic material, while the first less valuable fraction 9 is formed by non-magnetic material which in the present case is discarded as mine waste 35 (waste material).

The fine material 11 of the first classification installation K1 reaches a second classification installation K2 which may be configured as a sieve, a static screen, or a dynamic screen, for example. Said second classification installation K2 has a second coarse-material outlet 12 which is connected to a second sorting installation S2. The second sorting installation S2 may again be formed by a sensor-supported sorting installation, a dry jigger, or dry magnetic separation. Said second sorting installation S2 is again equipped with a first outlet 13 which is connected to the mill M1, in order to return a second valuable fraction 14 to the mill for renewed comminution. A second less valuable fraction 15 is discarded via a second outlet 16 of the second sorting installation S2. While the coarse material 17 of the second classification installation K2 reaches the second sorting installation via the second coarse-material outlet 12, the fine material 18 of the second classification installation K2 is fed via the second fine-material outlet 19 to a third classification installation K3 which preferably is configured as a dynamic screen and has a third coarse-material outlet 20 and a third fine-material outlet 21. The coarse material 22 which is created in the third classification installation K3 is to a third sorting installation S3 having an outlet 23 for a third less valuable fraction 24 and an outlet 25 for a third valuable fraction 26. While the third less valuable fraction 24 is again discarded from the milling circuit, the third valuable fraction 26 reaches a fourth classification installation K4 which may be formed, in particular, by a hydro cyclone or a screen.

The fourth classification installation K4 is connected via a fourth coarse-material outlet 27 to a second mill M2, in order to form a second milling circuit. Coarse material 28 of the fourth classification step K4 is thus further comminuted in the second mill M2 and, together with the third valuable fraction 26, makes its way back as comminuted material 29 to the fourth classification installation 4. Preferably, the second mill M2 is formed by an agitator ball mill.

The fourth classification installation K4 furthermore has a fourth fine-material outlet 30 which is connected to a fourth sorting installation S4. Moreover, the fine material 39 of the third classification installation K3, which is discharged via the third fine-material outlet 21, is fed to the fourth sorting installation S4. A fourth less valuable fraction 32 is discarded via an outlet 31 of the fourth sorting installation S4, while a fourth valuable fraction 34 which represents the truly valuable concentrate of the material 1 to be processed is ejected via an outlet 33. The first to fourth less valuable fractions 9, 15, 24, 32 represent the waste material or the so-called mine waste 35.

The individual sorting installations S1 to S4 are to be configured in a manner corresponding to the respective grain size to be processed, wherein the material 1 to be processed has a grain size of about 20 to 100 mm, for example. The separation limit of the first classification installation K1 is 1 to 10 mm, for example. The second classification installation K2 is then conceived so as to have a separation limit of about 100 to 1000 μm, for example. The third classification installation K3 and the fourth classification installation K4 then have the separation limit of approx. 45 μm, for example, which is optimal for the fourth valuable fraction. In order to achieve effective sorting of fine material of this type (grain size ≦45 μm), the fourth sorting installation S4 preferably operates according to the principle of fluidized bed sorting or wet magnetic separation.

All preceding classifications/screenings in the classification installations K1, K2, or K3, respectively, and the sorting processes in the first to the third sorting installations S1 to S3 are carried out as dry processing. This has the advantage that the requirement of process water may be reduced to a minimum. In this way, water is at the earliest employed after the third sorting process, at which point in time a large part of the less valuable fraction of the original material has already been discarded from the process by way of the preliminary mine-waste separation. On account thereof, water consumption may be considerably reduced (10 to 20%). The third and fourth sorting processes may also be carried out in a dry manner, in particular if fluidized bed sorting is employed.

FIG. 2 shows a block diagram of a system according to FIG. 1, which however is operated for processing material 1′ having a comparatively high water content of, for example, >4% by weight, using hot gas in the first three classification or screening processes, respectively. Otherwise, the system substantially corresponds to the construction which is described in FIG. 1, wherein for the sake of clarity the lines emanating from the sorting installations have not been drawn. There is the addition of a hot gas generator 36 which generates hot gas 37. The first and second classification installations K1 and K2 are thus correspondingly configured as a static or dynamic screen, respectively. The fine material of each screen is in each case conveyed together with the hot gas to the next screen.

The connection lines in which a mixture of solid material and gas flows are illustrated with dashed lines in FIG. 2. The connection lines in which only material is transported are implemented with solid lines, and the connection lines in which there is only hot gas are dot-dashed.

A separator 38 which is configured as a filter or a cyclone is provided ahead of the fourth sorting installation S4, in order for the third fine material 39 of the third classification installation K3, which is likewise configured as a screen, to be separated from the hot gas 37′ which is being used. In the fourth sorting installation S4, the third fine material 39 is again sorted into the fourth valuable fraction 34 and the fourth less valuable fraction 31. The hot air 37′ which is being used is returned with the aid of a blower 40, in order to be used again in the classification installations or screens, respectively. Setting of the desired temperature of the hot gas in the first classification installation K1 is influenced by way of the hot gas generator 36, in that the required amount of fresh hot gas 37 is added by mixing. Accordingly, a corresponding part of the hot gas 37′ being used is also not returned but discarded from the system via a filter 41 and optionally a further blower 42. Of course, there is the possibility for the recirculated part of the hot gas 37′ not to be exclusively imparted to the first classification installation K1. Optionally, the entire flow or a part-flow may also be fed first to the second or third classification installation K2, K3.

By using the hot gas, the material 1′ to be processed or the comminuted material 2′, respectively, may not only be screened but simultaneously also be dried in order for the efficiency of the screen to be increased.

1.-16. (canceled)

17. A method for processing ore-containing material, wherein:
the material is comminuted in at least one first mill (M1);
the comminuted material is classified in a first classification into coarse and fine material, wherein at least part of the coarse material of the first classification is returned to the first mill (M1), and
the fine material of the first classification is classified in a second classification again into coarse and fine material; wherein
the coarse material of the first classification is subjected to a first sorting into a first valuable and a first less valuable fraction, wherein the first valuable fraction is returned to the first mill (M1) and the less valuable fraction is discarded;
the coarse material of the second classification is subjected to a second sorting into a second valuable and a second less valuable fraction, wherein the second valuable fraction is returned to the first mill (M1) and the second less valuable fraction is discarded; and
the fine material of the second classification is subjected to a third classification and subsequently to at least one third sorting.

18. The method of claim 17 wherein the coarse material created in the third classification is subjected to the third sorting into a third valuable and a third less valuable fraction, wherein at least part of the third valuable fraction is further comminuted in a second mill (M2).

19. The method of claim 18 wherein the third valuable fraction which is comminuted in the second mill (M2) is subsequently subjected to a fourth sorting into a fourth valuable and a fourth less valuable fraction.

20. The method of claim 17 wherein fine material which is created in the third classification is subjected to a further sorting, in particular a fourth sorting into a fourth valuable and a fourth less valuable fraction.

21. The method of claim 17 wherein at least one of the first, second and third classification is one of sieving and pneumatic screening using one of a static and dynamic screen.

22. The method of claim 17 wherein the sorting into the respective valuable and the respective less valuable fraction is one of dry magnetic separating, wet magnetic separating, sensor-supported sorting and dry density sorting.

23. The method of claim 17 wherein at least one of the first, second and third classification is performed with a hot gas flow.

24. The method of claim 20 wherein the fine material which is created in the third screening, together with the hot gas flow, is fed to a separator, wherein the hot gas flow which is separated there is returned to the first classification installation (K1) and the fine material is fed to further sorting.

25. A system for processing ore-containing material, the system comprising:
at least one first mill (M1) for comminuting the material;
a first classification installation (K1) for classifying the material which is comminuted in the first mill (M1), having a first fine-material outlet and a first coarse-material outlet, wherein the first coarse-material outlet is connected to the first mill (M1) in order for coarse material to be recirculated;
a second classification installation (K2) which is connected to the first fine-material outlet of the first classification installation (K1), having a second fine-material outlet and a second coarse-material outlet;
a first sorting installation which is connected to the first coarse-material outlet of the first classification installation (K1), having a first outlet for a first valuable fraction and a second outlet for a first less valuable fraction, wherein the first outlet is connected to the mill (M1) in order for the first valuable fraction to be recirculated;
a second sorting installation (S2) which is connected to the second coarse-material outlet of the second classification installation (K2), having a first outlet for a second valuable fraction and a second outlet for a second less valuable fraction, wherein the first outlet is connected to the mill (M1) in order for the second valuable fraction to be recirculated;
a third classification installation (K3) which is connected to the second fine-material outlet of the second classification installation (K2); and
a third sorting installation (S3) which is connected to the third classification installation (K3).

26. The system of claim 25 further comprising:
a fourth sorting installation (S4) which is connected to the third classification installation (K3).

27. The system of claim 26 wherein the third classification installation (K3) has a third fine-material outlet and a third coarse-material outlet, wherein the third fine-material outlet is connected to the fourth sorting installation (S4).

28. The system of claim 25 wherein the third classification installation (K3) has a third fine-material outlet and a third coarse-material outlet, wherein the third coarse-material outlet is connected to the third sorting installation (S3).

29. The system as claimed in claim 25, characterized in that the third sorting installation (S3) has an outlet for a third valuable fraction and an outlet for a third less valuable fraction, wherein the outlet for the third valuable fraction is connected via a fourth classification installation (K4) to a second mill (M2) for comminuting the third valuable fraction.

30. The system of claim 29 wherein the second mill (M2) has an outlet for comminuted material which is connected to a fourth classification installation (K4), wherein the fourth classification installation (K4) comprises a fourth fine-material outlet and a fourth coarse-material outlet which is connected to the second mill (M2).

31. The system of claim 30 wherein the fourth fine-material outlet is connected to the fourth sorting installation (S4) which has an outlet for a fourth valuable fraction and an outlet for a fourth less valuable fraction.

32. The system of claim 25 wherein the first and second classification installations (K1, K2) are configured as one of a sieve and a screen, and at least one of the first, second and third classification installation (K1, K2, K3) is connected to a hot gas generator.

33. The system of claim 26 wherein the separator for separating the material from the hot gas is provided between the third classification installation (K3) and the fourth sorting installation (S4).
